(19) United States
(12) Patent Application Publication
(10) Pub. No.: US 2026/0135432 A1
(43) Pub. Date: May 14, 2026

(54) BRUSHLESS MOTOR

(71) Applicant: AAC MICROTECH (CHANGZHOU) CO., LTD., Changzhou (CN)

(72) Inventors: Jinguo Wu, Changzhou (CN); Sensen Yang, Changzhou (CN); Feng Yan, Changzhou (CN); Junsheng Wang, Changzhou (CN)

(21) Appl. No.: 19/326,717

(22) Filed: Sep. 11, 2025

Related U.S. Application Data
(63) Continuation of application No. PCT/CN2024/131616, filed on Nov. 12, 2024.

(51) Int. Cl. H02K 5/16; H02K 1/2706; H02K 11/215

(52) U.S. Cl. CPC H02K 5/161; H02K 1/2706; H02K 11/215; H02K 2211/03

(57) ABSTRACT

The present application provides a brushless motor including a housing, a front cover, a bracket, a stator assembly, a rotor assembly, a circuit board, and a sensor assembly. The stator assembly is provided around the rotor assembly, and the rotor assembly includes a rotor shaft and a permanent magnet fixedly sleeved on the rotor shaft. The rotor shaft includes a rotor shaft body and two flat portions formed by recessing the rotor shaft body. The sensor assembly includes a sensor magnet and a Hall sensor, and the sensor magnet includes a magnet body and a fixing hole formed through the magnet body. The flat portions are fixed in the fixing hole. Magnetizing directions of the permanent magnet and the sensor magnet are perpendicular to the flat portions. The brushless motor has consistent directions for the main and secondary magnetic fields, high rotation data detection accuracy, and excellent torque performance.

### CROSS-REFERENCE TO RELATED APPLICATIONS

This application is a continuation of International Application No. PCT/CN 2024/131616, filed on Nov. 12, 2024, the entire contents of which are incorporated herein by reference.

### TECHNICAL FIELD

The present application relates to the field of motor technologies, in particular to a brushless motor.

### BACKGROUND

Brushless motors, characterized by their compact structure, high power density, high operational efficiency, and significant energy-saving benefits, have been widely applied in fields such as electric motors and generators. In recent years, the industrial sector has increasingly demanded equipment that uses brushless motors to directly drive loads. The widespread application of these direct-drive devices powered by brushless motors is expected to yield immeasurable energy-saving benefits.

In the related art, most of the traditional brushless motors include a front cover, a rotor and a stator spaced around the rotor, a bracket and a sensor assembly. The front cover and the bracket are provided at opposite ends of the stator, and the rotation of the motor is realized by mutual driving of the stator and the rotor. The stator includes a housing fixed to the front cover and a winding fixed in the housing, the rotor generally includes a rotor shaft and a magnet fixed to an outer peripheral side of the rotor shaft, and the rotation of the motor is realized by mutual driving of the magnet and the winding. The sensor assembly includes a sensor magnet fixedly sleeved on the rotor shaft and a Hall sensor fixed to the bracket, and the Hall sensor is set relative to the sensor magnet. However, the traditional sensor magnet and the rotor shaft are joined using a rounded-head fit, causing the main magnetic field direction and the secondary magnetic field direction to remain unfixed, resulting in magnetic fields being set at arbitrary angles. This leads to randomness in the interference level of the main magnetic field on the secondary magnetic field, causing significant fluctuations in the detection and calibration accuracy of the Hall sensor. Additionally, the random interference of the secondary magnetic field on the main magnetic field causes substantial fluctuations in the motor's torque performance.

Therefore, it is necessary to provide a new brushless motor to solve the above technical problems.

### SUMMARY

An object of the present application is to provide a brushless motor with aligned main and secondary magnetic field directions, high rotational data detection accuracy, and excellent torque performance.

In order to achieve the above object, the present application provides a brushless motor including:
a housing;
a front cover and a bracket mounted at two ends of the housing, respectively;
a rotor assembly rotatably connected and supported at both ends by the front cover and the bracket, respectively;
a stator assembly fixed to an inner side of the housing; the stator assembly being provided around and spaced from the rotor assembly;
a circuit board fixed to a side of the bracket away from the housing; and
a sensor assembly;
wherein the rotor assembly includes a rotor shaft and a permanent magnet fixedly sleeved on the rotor shaft, wherein the rotor shaft is rotatably connected to the front cover and the bracket, and the permanent magnet is spaced from the stator assembly; the rotor shaft includes a rotor shaft body rotatably connected to the front cover and the bracket and two flat portions parallel to each other, which are formed by recessing an outer peripheral side of an end of the rotor shaft body close to the circuit board;
the sensor assembly includes a sensor magnet fixedly sleeved on an end of the rotor shaft away from the front cover and a Hall sensor fixed to a side of the circuit board close to the bracket, wherein the Hall sensor is arranged opposite to and spaced from the sensor magnet while remaining within a magnetic field range of the sensor magnet; the sensor magnet includes a magnet body and a fixing hole formed through the magnet body; a shape of the fixing hole is matched with a switch on an end of the rotor shaft body close to the circuit board, and the flat portions are inserted and fixed in the fixing hole;
wherein a magnetizing direction of the permanent magnet is perpendicular to the flat portions, and a magnetizing direction of the sensor magnet is perpendicular to the flat portions.

In an embodiment, the fixing hole includes two flat edges provided opposite to each other and two curved sidewalls connecting the same ends of the two flat edges, wherein the two flat portions are affixed to the two flat edges.

In an embodiment, an outer periphery of the magnet body is formed with two straight edges parallel to each other and two curved edges connecting the same ends of the two straight edges, wherein the straight edges are perpendicular to the flat portions.

In an embodiment, the housing includes a hollow columnar housing body, an annular connecting portion formed by one end of the housing body extending radially inwardly, and a positioning hole formed through the connecting portion; the front cover includes a front cover body, an annular first tab formed by a protruding extension of a side of the front cover body close to the housing, a second tab formed by a protruding extension of a side of the first tab close to the housing, a positioning post formed by a protruding extension of the side of the first tab close to the housing, and a through-hole axially arranged through the second tab along an axial direction of the second tab; a side of the connecting portion close to the front cover is abutted against the first tab, an inner side of the connecting portion is sleeved on an outer periphery of the second tab, and the positioning post is inserted and fixed in the positioning hole; the stator assembly is fixed to an inner sidewall of the housing body, and an end of the rotor assembly is inserted in the through-hole and rotatably connected to the through-hole.

In an embodiment, the housing further includes a plurality of limiting grooves formed by recessing the other end of the housing body along its axial direction, and limiting walls formed by a protruding extension of a side of each of the limiting grooves close to the bracket; the bracket includes a bracket body, an annular contact portion formed by a protruding extension of a side of the bracket body away from the housing, a limiting bump formed by protruding from an outer peripheral side of the bracket body, and an avoidance groove formed by recessing the outer peripheral side of the bracket body; the limiting bump and the avoidance groove are distributed along a circumferential direction of the bracket body, and the limiting bump is provided at a groove opening of the avoidance groove; the bracket body is inserted at an end of the housing body and fixed to an inner sidewall of the housing body, a side of the contact portion close to the housing body is abutted against the housing body, the limiting bump is provided in the limiting groove, and the limiting walls are provided in the avoidance groove; the other end of the rotor assembly is supported on the bracket body and rotatably connected to the bracket body.

In an embodiment, the bracket further includes at least two third tabs formed by a protruding extension of a side of the bracket body away from the housing; the circuit board includes a circuit board body and at least two groove opening structures formed by recessed intervals in the circuit board body, wherein each of the third tabs is provided within one of the groove opening structures, respectively.

In an embodiment, the stator assembly includes a coil winding coaxially provided with the housing and fixed to the housing.

In an embodiment, the brushless motor further includes a first bearing, which is fixedly sleeved on an end of the rotor shaft close to the front cover, wherein an outer periphery of the first bearing is fixed within the front cover.

In an embodiment, the brushless motor further includes a second bearing, which is sleeved on an end of the rotor shaft away from the front cover, wherein an outer periphery of the second bearing is fixed within the bracket.

In an embodiment, the rotor assembly further includes an iron core, which is fixedly sleeved between the rotor shaft and the permanent magnet.

Compared to the related art, in the brushless motor of the present application, the rotor assembly is rotatably connected to the housing by fixing the stator assembly inside the housing, the stator assembly is provided around the rotor assembly and spaced from the rotor assembly. The permanent magnet and the stator assembly are spaced from each other. The rotor shaft includes a rotor shaft body rotatably connected to the front cover and the bracket, and two flat portions parallel to each other, which are formed by recessing an outer peripheral side of an end of the rotor shaft body close to the circuit board. The sensor magnet is fixed to the rotor shaft, and the Hall sensor is fixed to the circuit board and located in the magnetic field range of the sensor magnet. The sensor magnet includes a magnet body and a fixing hole formed through the magnet body. A shape of the fixing hole is matched with a switch on an end of the rotor shaft body close to the circuit board, and the flat portions are inserted and fixed to the fixing hole. A magnetizing direction of the permanent magnet is perpendicular to the flat portions, and a magnetizing direction of the sensor magnet is perpendicular to the flat portions. By adopting a dual-flat configuration for the fit between the sensor magnet and the rotor shaft, the magnetization direction of the permanent magnet is perpendicular to the flat portions. The rotor assembly is first assembled and then magnetized. The magnetizing direction of the sensor magnet is perpendicular to the flat portions, and the design of the flat portions ensures alignment between the main and secondary magnetic field directions. This alignment minimizes the variation in mutual interference between the main and secondary magnetic fields, improving the accuracy and calibration precision of the Hall sensor, as well as enhancing the torque performance of the motor.

### BRIEF DESCRIPTION OF THE DRAWINGS

In order to more clearly illustrate the technical solutions in the embodiments of the present application, the accompanying drawings that need to be used in the description of the embodiment will be briefly introduced as follows. Obviously, the accompanying drawings in the following description are only some of the embodiments of the present application, and for the person of ordinary skill in the field, other accompanying drawings may be obtained based on these drawings without putting forth any creative labor.

FIG. 1 is a schematic diagram of a three-dimensional structure of a brushless motor according to an embodiment of the present application.

FIG. 2 is an exploded view of the three-dimensional structure of the brushless motor according to an embodiment of the present application.

FIG. 3 shows a sectional view of the brushless motor of FIG. 1 along the line A-A.

FIG. 4 is a structural schematic diagram of a housing according to an embodiment of the present application.

FIG. 5 is a structural schematic diagram of a bracket according to an embodiment of the present application.

FIG. 6 is a sectional view of the brushless motor of FIG. 1 along the line B-B.

FIG. 7 is a partially enlarged view of FIG. 6 at C.

In the figures, 100, brushless motor; 1, housing; 11, housing body; 12, connecting portion; 13, limiting groove; 14, limiting wall; 15, positioning hole; 2, stator assembly; 3, rotor assembly; 31, permanent magnet; 32, iron core; 33, rotor shaft; 331, rotor shaft body; 332, flat portion; 4, front cover; 41, front cover body; 42, first tab; 43, second tab; 44, positioning post; 45, through-hole; 5, bracket; 51, bracket body; 52, contact portion; 53, limiting block; 54, avoidance groove; 55, third tab; 6, circuit board; 61, circuit board body; 62, groove opening structure; 7, outlet terminal; 8, first bearing; 9, second bearing; 10, sensor assembly; 101, sensor magnet; 1011, magnet body; 10111, curved edge; 10112, straight edge; 1012, fixing hole; 10121, flat edge; 10122, sidewall; and 102, Hall sensor.

### DETAILED DESCRIPTION OF THE EMBODIMENTS

The technical solutions in the embodiments of the present application will be described clearly and completely in the following in conjunction with the accompanying drawings in the embodiments of the present application. Obviously, the described embodiments are only a part of the embodiments of the present application and not all of the embodiments. Based on the embodiments in the present application, all other embodiments obtained by a person of ordinary skill in the art without making creative labor fall within the scope of protection of the present application.

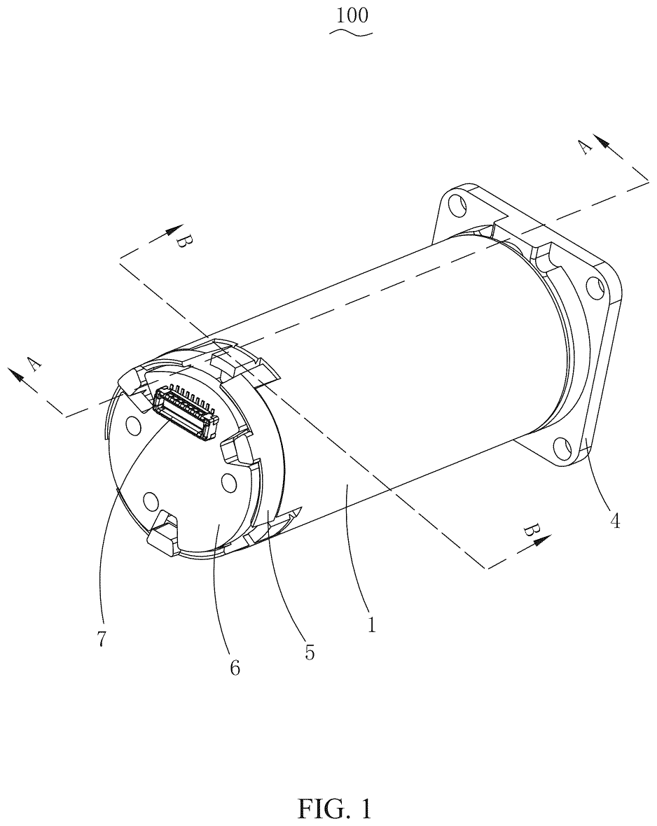

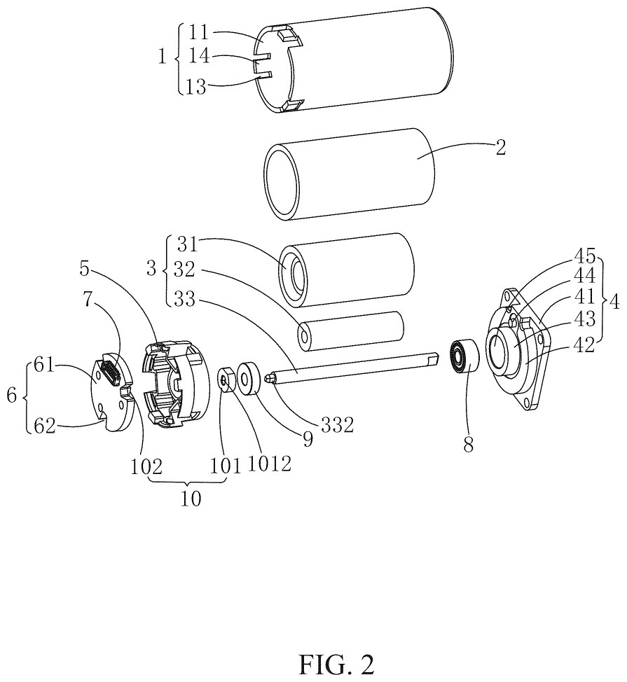

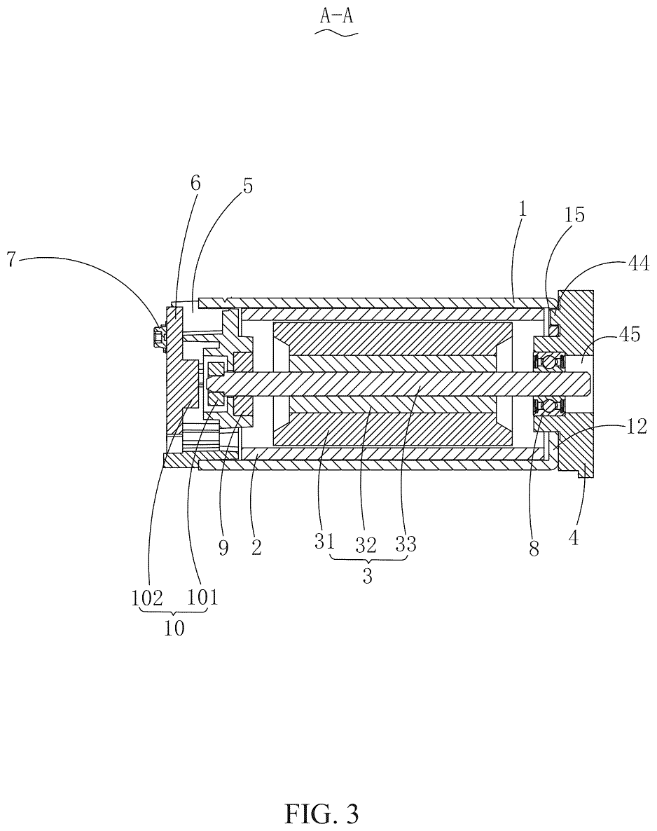

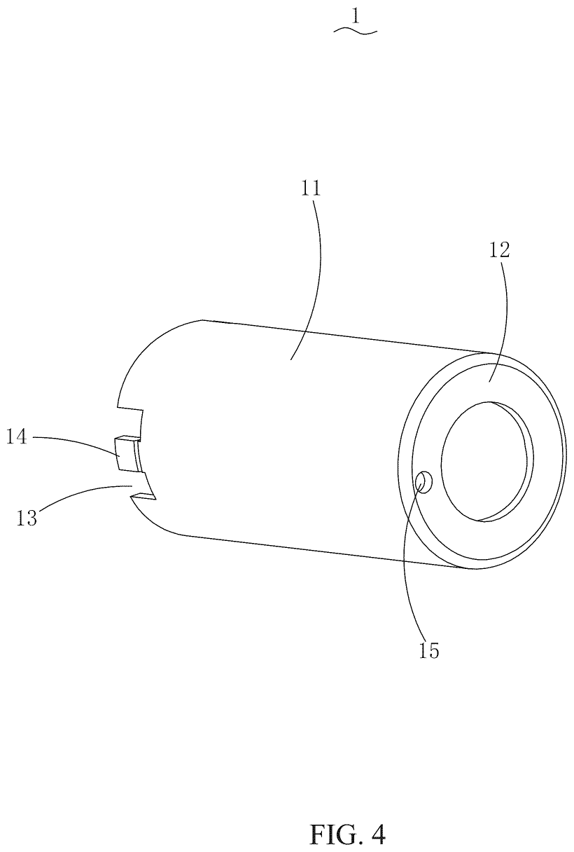

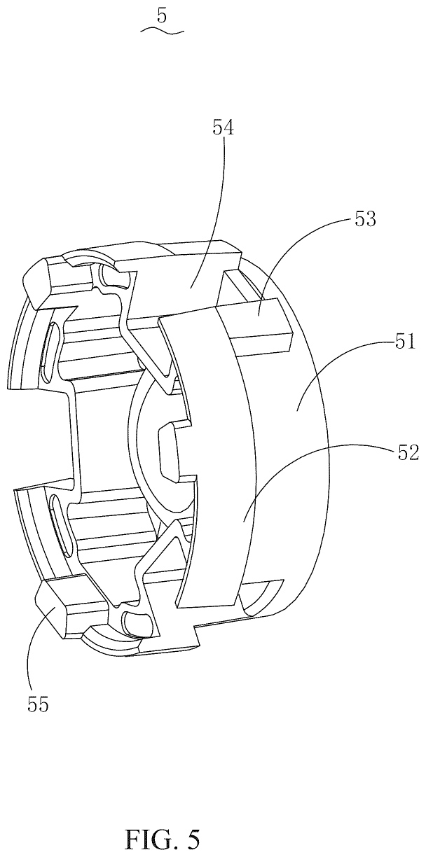

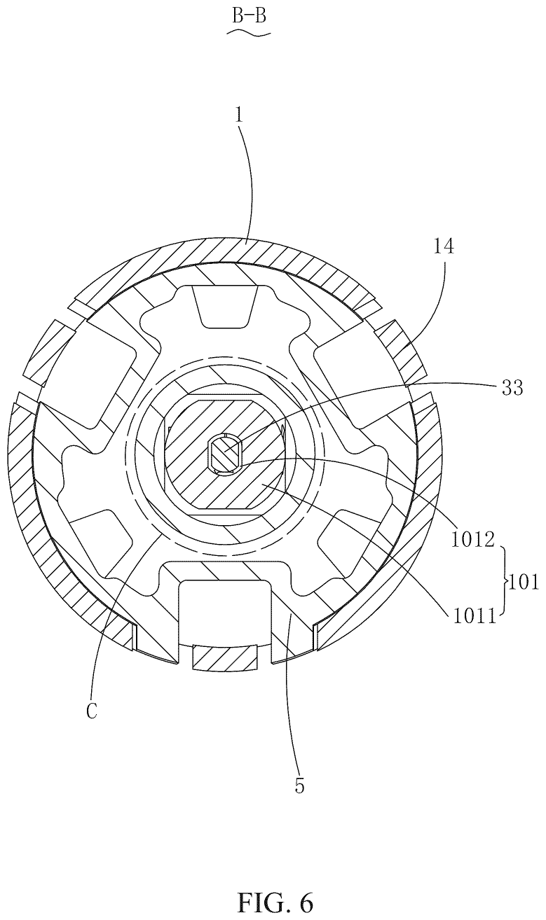

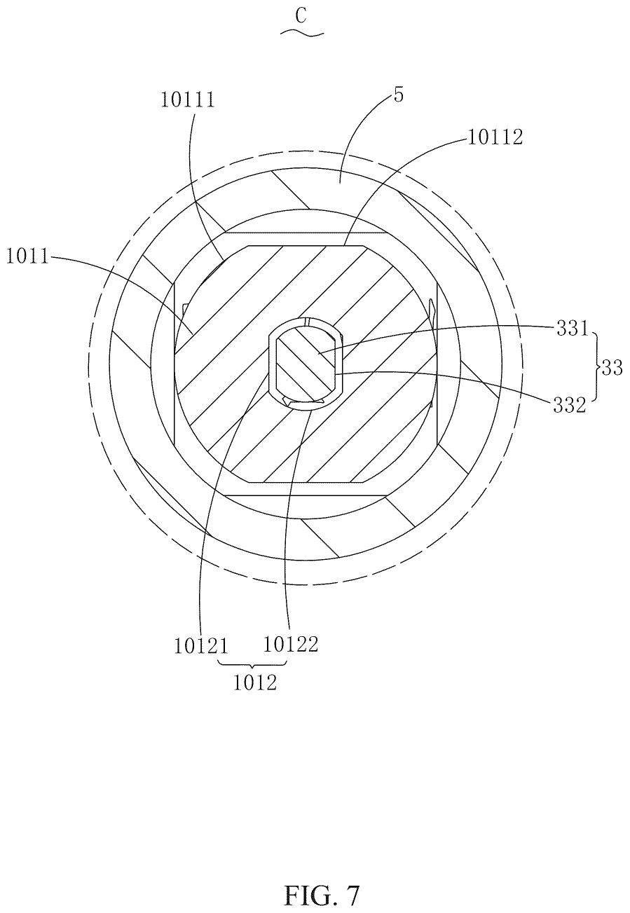

As shown in FIGS. 1 to 7, an embodiment of the present application provides a brushless motor 100 including a housing 1, a front cover 4 and a bracket 5 respectively mounted on two ends of the housing 1, a stator assembly 2 fixed to an inner side of the housing 1, a rotor assembly 3 supported on the front cover 4 and bracket 5 and rotatably connected to the front cover 4 and bracket 5, a circuit board 6 fixed to a side of the bracket 5 away from the housing 1, and a sensor assembly 10. The stator assembly 2 is provided around the rotor assembly 3 and spaced from the rotor assembly 3.

In this embodiment, a side of the circuit board 6 away from the housing is fixedly provided with an outlet terminal 7, and the outlet terminal 7 is configured to connect to an external power source to realize power supply.

The rotor assembly 3 includes a rotor shaft 33 and a permanent magnet 31 fixedly sleeved on the rotor shaft 33. The rotor shaft 33 is rotatably connected to the front cover 4 and the bracket 5, and the permanent magnet 31 is spaced from the stator assembly 2. The rotor shaft 33 includes a rotor shaft body 331 rotatably connected to the front cover 4 and the bracket 5 and two flat portions 332 parallel to each other, which are formed by recessing an outer peripheral side of an end of the rotor shaft body 331 close to the circuit board 6.

The sensor assembly 10 includes a sensor magnet 101 fixedly sleeved on an end of the rotor shaft 33 away from the front cover 4 and a Hall sensor 102 fixed to a side of the circuit board 6 close to the bracket 5. The Hall sensor 102 is arranged opposite to and spaced from the sensor magnet 101 while remaining within a magnetic field range of the sensor magnet 101. The sensor magnet 101 includes a magnet body 1011 and a fixing hole 1012 formed through the magnet body 1011. A shape of the fixing hole 1012 is matched with a switch on an end of the rotor shaft body 331 close to the circuit board 6, and the flat portions 332 are inserted and fixed in the fixing hole 1012. A magnetizing direction of the permanent magnet 31 is perpendicular to the flat portions 332, and a magnetizing direction of the sensor magnet 101 is perpendicular to the flat portions 332. By adopting a dual-flat configuration for the fit between the sensor magnet 101 and the rotor shaft 33, the magnetization direction of the permanent magnet 31 is perpendicular to the flat portions 332. The rotor assembly 3 is first assembled and then magnetized. The magnetizing direction of the sensor magnet 101 is perpendicular to the flat portions 332, and the design of the flat portions 332 ensures alignment between the main and secondary magnetic field directions. This alignment minimizes the variation in mutual interference between the main and secondary magnetic fields, improving the accuracy and calibration precision of the Hall sensor, as well as enhancing the torque performance of the motor.

In this embodiment, the fixing hole 1012 includes two flat edges 10121 provided opposite to each other and two curved sidewalls 10122 connecting the same ends of the two flat edges 10121. The two flat portions 332 are affixed to the two flat edges 10121.

The housing 1 is configured to fix the stator assembly 2 and support the rotation of the rotor assembly 3, and the overall motor rotation is realized by generating mutual magnetic fields between the stator assembly 2 and the rotor assembly 3 to drive the rotor assembly 3 to rotate.

In this embodiment, an outer periphery of the magnet body 1011 is formed with two straight edges 10112 parallel to each other and two curved edges 10111 connecting the same ends of the two straight edges 10112. The straight edges 10112 are perpendicular to the flat portions 332, thereby facilitating the assembly of the magnet body 1011 with the rotor shaft 33.

In this embodiment, the housing 1 includes a hollow columnar housing body 11, an annular connecting portion 12 formed by one end of the housing body 11 extending inwardly along its radial direction, and a positioning hole 15 formed through the connecting portion 12.

In this embodiment, the front cover 4 includes a front cover body 41, an annular first tab 42 formed by a protruding extension of a side of the front cover body 41 close to the housing 1, a second tab 43 formed by a protruding extension of a side of the first tab 42 close to the housing 1, a positioning post 44 formed by a protruding extension of the side of the first tab 42 close to the housing 1, and a through-hole 45 axially arranged through the second tab 43 along an axial direction of the second tab 43. A side of the connecting portion 12 close to the front cover 4 is abutted against the first tab 42, an inner side of the connecting portion 12 is sleeved on an outer periphery of the second tab 43, and the positioning post 44 is inserted and fixed in the positioning hole 15. The stator assembly 2 is fixed to an inner sidewall of the housing body 11, and the rotor assembly 3 is set in the through-hole 45 and rotatably connected to the through-hole 45. By abutting the first tab 42 of the front cover 4 against the end face of the housing 1 and providing the second tab 43 inside the housing 1, the positioning post 44 is inserted inside the positioning hole 15, so that the positioning post 44 forms an anti-misassembly mating setup with the positioning hole 15, thereby facilitating the assembly between the front cover 4 and the housing 1.

In this embodiment, the housing 1 further includes a plurality of limiting grooves 13 formed by recessing the other end of the housing body 11 along its axial direction, and limiting walls 14 formed by a protruding extension of a side of each of the limiting grooves 13 close to the bracket 5. The front cover 4 is fixed to the connecting portion 12, the stator assembly 2 is fixed to an inner wall of the housing body 11, and the bracket 5 is provided inside the other end of the housing body 11 and is fixedly engaged with the limiting wall 14. The housing body 11 is configured to fixedly install the stator assembly 2, and the connecting portion 12 is fixedly welded to the front cover 4, so that the front cover 4 and the housing 1 are well fixed as a whole.

In this embodiment, the bracket 5 includes a bracket body 51, an annular contact portion 52 formed by a protruding extension of a side of the bracket body 51 away from the housing 1, a limiting bump 53 formed by protruding from an outer peripheral side of the bracket body 51, and an avoidance groove 54 formed by recessing the outer peripheral side of the bracket body 51. The limiting bump 53 and the avoidance groove 54 are distributed along a circumferential direction of the bracket body 51, and the limiting bump 53 is located at a groove opening of the avoidance groove 54. The bracket body 51 is inserted at an end of the housing body 11 and fixed to the inner sidewall of the housing body 11. A side of the contact portion 52 close to the housing body 11 is abutted against the housing body 11. The limiting bump 53 is provided in the limiting groove 13, and the limiting walls 14 are provided within the avoidance groove 54. The other end of the rotor assembly 3 is supported on the bracket body 51 and rotatably connected to the bracket body 51. By positioning the limiting walls 14 within the avoidance groove 54, the limiting bump 53 is engaged in the limiting groove 13, thereby achieving an anti-misassembly fit between the limiting groove 13 and the limiting bump 53.

In an embodiment, the limiting bump 53 is a limiting block or a limiting post or the like.

In this embodiment, the bracket 5 further includes at least two third tabs 55 formed by a protruding extension of a side of the bracket body 51 away from the housing 1. The circuit board 6 includes a circuit board body 61 and at least two groove opening structures 62 formed by recessed intervals in the circuit board body 61. Each of the third tabs 55 is provided within one of the groove opening structures 62, respectively. By configuring the third tabs 55 and the groove opening structures 62 to form the anti-misassembly chain, effective mutual positioning is achieved between the bracket 5 and the circuit board 6. This ensures that the wire outlet position of the wire outlet terminal 7 aligns with the direction of the front cover 4 and the limiting bump 53, collectively achieving uniformity in the wire outlet position of the motor.

In this embodiment, the stator assembly 2 includes a coil winding coaxially provided with the housing and fixed to the housing 1. The coil winding may be a plurality of magnetic sheets stacked in a ring shape. By energizing the coil winding, a magnetic field is generated through the interaction between the coil winding and the rotor assembly 3, thereby driving the rotation of the rotor assembly 3.

In this embodiment, the brushless motor 100 further includes a first bearing 8, which is fixed to an end of the rotor shaft 33 close to the front cover 4. The first bearing 8 is fixed to an outer periphery of the front cover 4. The first bearing 8 reduces the friction between the rotor shaft 33 and the front cover 4, thereby improving the rotational efficiency of the shaft 33.

In this embodiment, the brushless motor 100 further includes a second bearing 9, which is sleeved on one end of the rotor shaft 33 away from the front cover 4. The outer periphery of the second bearing 9 is fixed within the bracket 5. The second bearing 9 supports the rotor shaft 33 to be set within the bracket 5, resulting in good rotational stability of both ends of the rotor shaft 33.

In this embodiment, the rotor assembly 3 further includes an iron core 32, which is fixedly sleeved between the rotor shaft 33 and the permanent magnet 31. By adding the iron core 32, the magnetism of the permanent magnet 31 can be enhanced, thereby improving the performance of the brushless motor 100.

Compared to the related art, in the brushless motor of the present application, the rotor assembly is rotatably connected to the housing by fixing the stator assembly inside the housing, the stator assembly is provided around the rotor assembly and spaced from the rotor assembly. The permanent magnet and the stator assembly are spaced from each other. The rotor shaft includes a rotor shaft body rotatably connected to the front cover and the bracket, and two flat portions parallel to each other, which are formed by recessing an outer peripheral side of an end of the rotor shaft body close to the circuit board. The sensor magnet is fixed to the rotor shaft, and the Hall sensor is fixed to the circuit board and located in the magnetic field range of the sensor magnet. The sensor magnet includes a magnet body and a fixing hole formed through the magnet body. A shape of the fixing hole is matched with a switch on an end of the rotor shaft body close to the circuit board, and the flat portions are inserted and fixed to the fixing hole. A magnetizing direction of the permanent magnet is perpendicular to the flat portions, and a magnetizing direction of the sensor magnet is perpendicular to the flat portions. By adopting a dual-flat configuration for the fit between the sensor magnet and the rotor shaft, the magnetization direction of the permanent magnet is perpendicular to the flat portions. The rotor assembly is first assembled and then magnetized. The magnetizing direction of the sensor magnet is perpendicular to the flat portions, and the design of the flat portions ensures alignment between the main and secondary magnetic field directions. This alignment minimizes the variation in mutual interference between the main and secondary magnetic fields, improving the accuracy and calibration precision of the Hall sensor, as well as enhancing the torque performance of the motor.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. A brushless motor, comprising:
a housing;
a front cover and a bracket mounted at two ends of the housing, respectively;
a rotor assembly rotatably connected and supported at both ends by the front cover and the bracket, respectively;
a stator assembly fixed to an inner side of the housing; the stator assembly being provided around and spaced from the rotor assembly;
a circuit board fixed to a side of the bracket away from the housing; and
a sensor assembly;
wherein the rotor assembly comprises a rotor shaft and a permanent magnet fixedly sleeved on the rotor shaft, wherein the rotor shaft is rotatably connected to the front cover and the bracket, and the permanent magnet is spaced from the stator assembly; the rotor shaft comprises a rotor shaft body rotatably connected to the front cover and the bracket and two flat portions parallel to each other, which are formed by recessing an outer peripheral side of an end of the rotor shaft body close to the circuit board;
the sensor assembly comprises a sensor magnet fixedly sleeved on an end of the rotor shaft away from the front cover and a Hall sensor fixed to a side of the circuit board close to the bracket, wherein the Hall sensor is arranged opposite to and spaced from the sensor magnet while remaining within a magnetic field range of the sensor magnet; the sensor magnet comprises a magnet body and a fixing hole formed through the magnet body; a shape of the fixing hole is matched with a switch on an end of the rotor shaft body close to the circuit board, and the flat portions are inserted and fixed in the fixing hole;
wherein a magnetizing direction of the permanent magnet is perpendicular to the flat portions, and a magnetizing direction of the sensor magnet is perpendicular to the flat portions.

2. The brushless motor of claim 1, wherein the fixing hole comprises two flat edges provided opposite to each other and two curved sidewalls connecting the same ends of the two flat edges, wherein the two flat portions are affixed to the two flat edges.

3. The brushless motor of claim 2, wherein an outer periphery of the magnet body is formed with two straight edges parallel to each other and two curved edges connecting the same ends of the two straight edges, wherein the straight edges are perpendicular to the flat portions.

4. The brushless motor of claim 1, wherein the housing comprises a hollow columnar housing body, an annular connecting portion formed by one end of the housing body extending radially inwardly, and a positioning hole formed through the connecting portion; the front cover comprises a front cover body, an annular first tab formed by a protruding extension of a side of the front cover body close to the housing, a second tab formed by a protruding extension of a side of the first tab close to the housing, a positioning post formed by a protruding extension of the side of the first tab close to the housing, and a through-hole axially arranged through the second tab along an axial direction of the second tab; a side of the connecting portion close to the front cover is abutted against the first tab, an inner side of the connecting portion is sleeved on an outer periphery of the second tab, and the positioning post is inserted and fixed in the positioning hole; the stator assembly is fixed to an inner sidewall of the housing body, and an end of the rotor assembly is inserted in the through-hole and rotatably connected to the through-hole.

5. The brushless motor of claim 2, wherein the housing further comprises a plurality of limiting grooves formed by recessing the other end of the housing body along its axial direction, and limiting walls formed by a protruding extension of a side of each of the limiting grooves close to the bracket; the bracket comprises a bracket body, an annular contact portion formed by a protruding extension of a side of the bracket body away from the housing, a limiting bump formed by protruding from an outer peripheral side of the bracket body, and an avoidance groove formed by recessing the outer peripheral side of the bracket body; the limiting bump and the avoidance groove are distributed along a circumferential direction of the bracket body, and the limiting bump is provided at a groove opening of the avoidance groove; the bracket body is inserted at an end of the housing body and fixed to an inner sidewall of the housing body, a side of the contact portion close to the housing body is abutted against the housing body, the limiting bump is provided in the limiting groove, and the limiting walls are provided in the avoidance groove; the other end of the rotor assembly is supported on the bracket body and rotatably connected to the bracket body.

6. The brushless motor of claim 5, wherein the bracket further comprises at least two third tabs formed by a protruding extension of a side of the bracket body away from the housing; the circuit board comprises a circuit board body and at least two groove opening structures formed by recessed intervals in the circuit board body, wherein each of the third tabs is provided within one of the groove opening structures, respectively.

7. The brushless motor of claim 1, wherein the stator assembly comprises a coil winding coaxially provided with the housing and fixed to the housing.

8. The brushless motor of claim 1, further comprising a first bearing, which is fixedly sleeved on an end of the rotor shaft close to the front cover, wherein an outer periphery of the first bearing is fixed within the front cover.

9. The brushless motor of claim 8, further comprising a second bearing, which is sleeved on an end of the rotor shaft away from the front cover, wherein an outer periphery of the second bearing is fixed within the bracket.

10. The brushless motor of claim 1, wherein the rotor assembly further comprises an iron core, which is fixedly sleeved between the rotor shaft and the permanent magnet.
